(19) United States
(12) Patent Application Publication
(10) Pub. No.: US 2026/0268792 A1
(43) Pub. Date: Sep. 10, 2026

(54) METHOD AND SYSTEM FOR AUTOMATED SPEECH OUTPUT WITH PERSONALIZED VOICE CLONING TECHNOLOGY AND SYNCHRONOUS MARKING

(71) Applicant: CLELO- Gemeinnützige Gesellschaft zur digitalen Lese- und Sprachförderung gUG (haftungsbeschränkt), Regensburg (DE)

(72) Inventor: Herbert Endres, Regensburg (DE)

(21) Appl. No.: 19/562,550

(22) Filed: Mar. 10, 2026

(30) Foreign Application Priority Data
Mar. 10, 2025 (DE) 1020251090548

(51) Int. Cl. G09B 17/00; G06F 40/30; G06F 40/58; G10L 13/033; G10L 13/047; G10L 13/10; G10L 15/22

(52) U.S. Cl. CPC G09B 17/006; G06F 40/30; G06F 40/58; G10L 13/033; G10L 13/047; G10L 13/10; G10L 15/22; G10L 2015/225

(57) ABSTRACT

A method and system for automated speech output with personalized voice cloning technology and synchronous marking. The method comprises generating a synthesized voice by way of voice cloning technology based on an initial voice recording (4), synchronously marking read text passages on a display device (1) in dependence on the speech output, controlling a reading speed, analyzing reading accuracy immediately during reading and/or immediately after each word, syllable, and/or morpheme by way of a real-time feedback system, and utilizing an AI-based model for recognizing and optimizing individual reading speed and/or reading accuracy. The system comprises a display device (1), an audio output system (2), optionally an audio input system, and a processing unit (3). Emotion-aware speech synthesis, biometric feedback, gamification, and offline operation are provided.

### CROSS-REFERENCE TO RELATED APPLICATIONS

This application claims the benefit of priority from German Patent Application No. DE 10 2025 109 054.8, filed on Mar. 10, 2025, the entire disclosure of which is incorporated herein by reference.

### FIELD OF THE DISCLOSURE

The present disclosure relates to a method and system for automated speech output using personalized voice cloning technology. More particularly, the disclosure relates to the synchronous marking of text passages in response to speech output and to the adaptation of playback speed for individual control of the output process, including the integration of adaptive learning mechanisms, interactive feedback systems, biometric sensing, emotion-aware speech synthesis, and accessibility interfaces for improving reading and language proficiency of a user.

### BACKGROUND

Conventional speech output systems frequently rely on standardized synthetic voices that offer little individual character for the user. Known text-to-speech systems provide a read-aloud function; however, they generally lack a well-integrated personalized reading voice. The marking of text in such systems often occurs asynchronously or at a static speed, which limits adaptability to individual user needs.

The ability to generate a synthesized voice based on an individual voice recording and to combine such a voice with dynamic, synchronous text marking has not been satisfactorily addressed by existing systems. Similarly, a flexible speed control that allows adaptive adjustment to user preferences or external conditions remains elusive in conventional approaches.

Modern developments in speech synthesis technology employ machine learning and neural networks for voice analysis and processing. Particularly advanced systems permit the generation of synthetic voices from only a few seconds of audio material. However, such methods have not been fully integrated into interactive reading and learning applications to date. Beyond personalized voices, systems for improving user experience may also employ adaptive voice modulation to generate varying intonations, volumes, and emotions depending on text content. Artificial intelligence may additionally be used to automatically recognize reading patterns and to adapt reading speed in dependence on user performance.

A further deficiency of existing systems resides in the absence of real-time coupling between speech output and reading accuracy analysis at the granularity of individual words, syllables, or morphemes. Conventional systems, where they incorporate feedback at all, typically operate on sentence-level or paragraph-level granularity, which is insufficient for targeted correction of specific reading errors. There remains a need for a system that analyzes reading accuracy immediately during reading and/or immediately after each word, syllable, and/or morpheme, and that provides correspondingly fine-grained feedback.

Existing systems also fail to account for the emotional content of the text being read aloud. A synthesized voice that reads an expressive passage with the same prosody as a factual passage provides a diminished user experience and reduces comprehension engagement. There is a need for emotion-aware speech synthesis that dynamically adapts prosody, pitch contour, speaking rate, and vocal timbre in response to semantic and affective features of the text.

Additionally, conventional reading assistance systems operate exclusively online and require a persistent network connection, rendering them unusable in environments with limited or no connectivity. For educational deployment in schools, libraries, or developing regions, an offline-capable system with local voice synthesis and on-device model inference would be desirable.

In view of the above, there is a need for a method and system for automated speech output that integrates personalized voice cloning technology with synchronous text marking and adaptive control of the output process, so as to address the deficiencies of conventional systems.

### SUMMARY

According to one aspect of the present disclosure, a method for automated speech output with personalized voice cloning technology and synchronous marking is provided. The method comprises generating a synthesized voice by way of voice cloning technology based on an initial voice recording, synchronously marking read text passages on a display device in dependence on the speech output, controlling a reading speed, integrating a real-time feedback system for analyzing reading accuracy immediately during reading and/or immediately after each word, syllable, and/or morpheme, and utilizing an AI-based model for recognizing and optimizing individual reading speed and/or reading accuracy.

According to another aspect of the present disclosure, a system for automated speech output with personalized voice cloning technology and synchronous marking is provided. The system comprises a display device, an audio output system, optionally an audio input system for capturing user speech, and a processing unit. The processing unit is configured to generate a synthesized voice by way of voice cloning technology based on an initial voice recording, to synchronously mark read text passages on the display device in dependence on the speech output, to control a reading speed, to analyze reading accuracy immediately during reading and/or immediately after each word, syllable, and/or morpheme by way of a real-time feedback system, and to utilize an AI-based model for recognizing and optimizing individual reading speed and/or reading accuracy.

### BRIEF DESCRIPTION OF THE DRAWINGS

The accompanying drawings, which are incorporated in and constitute a part of this specification, illustrate exemplary embodiments of this disclosure and, together with the description, serve to explain the principles of this disclosure. The drawings do not represent all embodiments of this disclosure and are not intended to be construed in a limiting sense.

FIG. 1 is a schematic diagram of a system for synchronized speech output with textual marking according to an embodiment of the present disclosure.

FIG. 2 is a flow diagram illustrating a process for generating a personalized synthesized voice according to an embodiment of the present disclosure.

FIG. 3 is a schematic representation of an exemplary user interface of a system for synchronized speech output according to an embodiment of the present disclosure.

FIG. 4 is a diagram illustrating the automatic adaptation of the reading speed in dependence on user interactions according to an embodiment of the present disclosure.

### DETAILED DESCRIPTION

Reference will now be made in detail to the preferred embodiments of the present disclosure, examples of which are illustrated in the accompanying figures. Wherever possible, the same reference numerals will be used throughout the drawings to refer to the same or like parts. The following description is provided by way of example only and is not intended to limit the scope of the disclosure.

According to the present disclosure, the method and system for automated speech output with personalized voice cloning technology and synchronous marking comprises the generation of a synthesized voice by way of voice cloning technology based on an initial voice recording, the synchronous marking of the read text passages on a display device in dependence on the speech output, the control of the reading speed, the integration of a real-time feedback system for analyzing reading accuracy, and the utilization of an AI-based model for recognizing and optimizing the individual reading speed. In at least one embodiment, the speech output may comprise both the playback of a synthesized voice generated by the voice cloning technology and, alternatively or additionally, the playback of the recorded voice itself.

In at least one embodiment, a self-learning system employing kernel technology is used to continuously optimize the speech output and to dynamically adapt the output based on prior user inputs. The kernel technology may comprise, for example, a support vector machine (SVM), a Gaussian process regression model, a radial basis function (RBF) kernel, a polynomial kernel, and/or combinations thereof. In certain embodiments, the kernel operates on feature vectors extracted from user interaction data, including but not limited to reading speed, pause frequency, error rate, scrolling behavior, and/or touch input patterns.

According to at least one further embodiment, the reading speed is automatically adapted to the reading pace of the user. Such adaptation may occur in real time or with a predetermined temporal delay. The adaptation may be based on eye-tracking data, on the frequency of user-initiated speed changes, on scrolling velocity, and/or on external parameters such as time of day or environmental noise level. The reading speed may range from about 50 words per minute to about 600 words per minute, preferably from about 80 words per minute to about 400 words per minute, more preferably from about 100 words per minute to about 300 words per minute, and most preferably from about 120 words per minute to about 250 words per minute.

In a particularly preferred embodiment, the speech output is combined with real-time speech analysis for the recognition of speech modulations and intonations. Such analysis may involve spectral analysis, formant tracking, fundamental frequency extraction, mel-frequency cepstral coefficient (MFCC) computation, and/or pitch detection algorithms. The recognized modulations and intonations may be stored in a user profile and used to improve the naturalness of subsequent speech synthesis outputs.

In at least one embodiment, the system stores individual reading profiles and uses them for adapting the speech output. A reading profile may comprise, without limitation, preferred reading speed, preferred voice characteristic(s), preferred marking mode, reading history, error patterns, and/or performance metrics. The reading profiles may be stored locally on the device, on a remote server, and/or in a cloud storage system. In certain embodiments, the reading profiles are encrypted and accessible only to the respective user.

According to at least one embodiment, the text marking occurs in the form of syllable-by-syllable, word-by-word, morpheme-by-morpheme, or sentence-by-sentence marking. The morpheme-by-morpheme marking mode segments the displayed text into its constituent morphemes, such as prefixes, roots, suffixes, and inflectional endings, and highlights each morpheme individually in synchronization with the corresponding portion of the speech output. Alternatively or additionally, the text marking may occur at the level of individual phonemes, clauses, or paragraphs. The marking may be visually realized by way of color highlighting, underlining, bolding, font size variation, background shading, border marking, and/or animation effects. The color of the marking may be selected from the group consisting of yellow, blue, green, orange, red, purple, and/or a user-defined color. In certain embodiments, the marking color adapts dynamically to the content type, for instance, using a first color for narrative text and a second, different color for dialogue.

In a further preferred embodiment, cloud storage of the personalized speech data is provided for cross-platform use. The cloud storage may employ encryption protocols selected from the group consisting of AES-128, AES-256, RSA-2048, TLS 1.3, and/or combinations thereof. Synchronization between devices may occur in real time, periodically at predetermined intervals, and/or upon user-initiated request.

In at least one embodiment, the system integrates multilingual support for simultaneous translations. The multilingual support may encompass at least two, preferably at least five, more preferably at least ten, and most preferably at least twenty languages. Translation may be performed by a neural machine translation (NMT) model, a transformer-based translation model, and/or a sequence-to-sequence model with attention mechanism. In certain embodiments, the personalized voice characteristics are maintained across languages, such that the user hears a translation in a voice that retains the prosodic features of the original personalized voice.

According to at least one embodiment, the control of the speech output occurs via a multimodal interface comprising voice input, touchscreen control, and/or gesture recognition. The gesture recognition may employ camera-based tracking, infrared-based tracking, ultrasound-based tracking, and/or radar-based tracking. The voice input may be processed by an automatic speech recognition (ASR) module configured to recognize commands in the language of the user. In alternative embodiments, the multimodal interface may additionally comprise brain-computer interface (BCI) signals, gaze-based input, and/or haptic feedback elements.

In at least one embodiment, neural networks for voice cloning are utilized to generate personalized voices with high naturalness and variable prosody. Zero-shot voice cloning technologies may be used to generate a lifelike reading voice from only a few seconds of speech material. The neural network architecture may be selected from the group consisting of variational autoencoders (VAE), generative adversarial networks (GAN), WaveNet, Tacotron, Tacotron 2, FastSpeech, FastSpeech 2, VITS, VALL-E, and/or combinations thereof. In certain embodiments, the voice cloning requires a voice sample of a duration ranging from about 1 second to about 120 seconds, preferably from about 3 seconds to about 60 seconds, more preferably from about 5 seconds to about 30 seconds, and most preferably from about 5 seconds to about 15 seconds.

According to at least one further embodiment, the system may employ speech synthesis algorithms based on diffusion models or autoregressive decoders to enable highly realistic speech output. The diffusion model may implement a denoising diffusion probabilistic model (DDPM), a score-based generative model, and/or a latent diffusion model. The autoregressive decoder may be based on a transformer architecture with self-attention and/or cross-attention mechanisms.

In at least one further embodiment, adaptive learning mechanisms are integrated that create individual reading profiles based on user data and automatically adapt the reading speed and intonation to the user's progress. This may be accomplished by machine learning that recognizes individual patterns in reading behavior and derives an optimized output therefrom. The adaptive learning mechanism may be based on reinforcement learning, supervised learning, unsupervised learning, and/or a combination thereof. In certain embodiments, the learning mechanism employs a multi-armed bandit algorithm, a contextual bandit algorithm, and/or a deep Q-network (DQN) for optimizing the speech output parameters.

According to at least one further embodiment, the system may comprise a real-time pronunciation analysis that detects errors and provides targeted corrections to the user, comparable to an interactive speech coach. The pronunciation analysis may evaluate phoneme accuracy, intonation contour, rhythm, stress patterns, and/or fluency. Feedback may be provided visually on the display device, auditorily through the audio output system, and/or haptically through a vibration motor of a mobile device.

In at least one particularly preferred embodiment, the real-time feedback system is configured to analyze reading accuracy immediately during reading and/or immediately after each word, each syllable, and/or each morpheme spoken by the user. To this end, the system may segment the speech output timeline into temporal windows corresponding to individual linguistic units and evaluate the user's concurrent or immediately subsequent response within each such window. The analysis granularity may be configurable by the user or may be automatically selected based on the user's proficiency level, wherein beginning readers may be assigned morpheme-level analysis and advanced readers may be assigned sentence-level analysis.

According to at least one embodiment, the system further comprises an audio input system for capturing speech of the user. The audio input system may comprise a microphone, a microphone array, and/or a directional microphone. The captured speech of the user is transmitted to the processing unit for comparison with the expected pronunciation derived from the text being read. In certain embodiments, the audio input system performs speaker verification to confirm that the captured speech originates from the registered user, thereby preventing unauthorized profile modification. The speaker verification may employ a speaker embedding comparison with a threshold similarity score, wherein the threshold may range from about 0.7 to about 0.99, preferably from about 0.85 to about 0.95.

In at least one further embodiment, the system may be combined with augmented reality (AR) technology to capture printed books or texts through an AR headset or AR glasses and to project the synchronized speech output directly onto the physical medium. The AR technology may employ marker-based tracking, marker-less tracking, simultaneous localization and mapping (SLAM), and/or depth-sensing cameras. In certain embodiments, the text recognition of the printed medium is performed by an optical character recognition (OCR) module.

In at least one further embodiment, integration into virtual reality (VR) environments may be provided, in which virtual avatars interact with the cloned voice to create an immersive learning experience. The virtual avatars may exhibit lip synchronization matched to the speech output, facial expressions adapted to the emotional content of the text, and/or body gestures appropriate to the narrative context.

According to at least one further embodiment, the system may combine multilingual speech synthesis with immediate translation, such that texts are simultaneously read aloud in another language using the personalized voice. The translation latency may be less than about 2000 milliseconds, preferably less than about 1000 milliseconds, more preferably less than about 500 milliseconds, and most preferably less than about 200 milliseconds.

In at least one further embodiment, a self-learning system with kernel technology may be integrated that continuously learns from user inputs and performs individual adaptations of the speech synthesis in real time. In particular, the system may dynamically adapt various voice modulations based on context, content, and user interaction through adaptive algorithms. The adaptive algorithms may comprise gradient descent optimization, Bayesian optimization, evolutionary strategies, and/or meta-learning approaches.

In order to train text and language comprehension, a lexicon function may be integrated that enables a user to click on a word that the user does not understand, whereupon an audio file, an explanation, and/or an image or illustration relating to the respective word is displayed. The lexicon function may be connected to one or more dictionaries, encyclopedias, and/or image databases. In certain embodiments, the lexicon function provides context-sensitive definitions that take into account the specific usage of the word within the text.

According to at least one embodiment, the processing unit is configured to perform a sentiment analysis and/or an emotion classification of the text to be read aloud prior to or concurrently with speech synthesis. The sentiment analysis may classify text segments into emotional categories selected from the group consisting of neutral, joyful, sad, angry, fearful, surprised, disgusted, and/or contemptuous. Based on the classified emotional category, the speech synthesis module adapts at least one of the following prosodic parameters: fundamental frequency (F0) contour, speaking rate, loudness, spectral tilt, jitter, shimmer, and/or voice quality (breathy, creaky, modal). In a preferred embodiment, the emotion-aware speech synthesis employs an emotion embedding vector that is concatenated with the speaker embedding vector prior to the decoder stage, such that the personalized voice retains its individual character while adopting the affective coloring appropriate to the text content. The emotion embedding may be generated by a text-based emotion classifier, which may be based on a bidirectional encoder representation from transformers (BERT), a RoBERTa model, a GPT-based classifier, and/or a purpose-trained convolutional neural network operating on word embeddings.

In a further preferred embodiment, the emotion-aware speech synthesis additionally takes into account the narrative arc of the text, such that gradual emotional transitions—for instance from calm exposition to tense dialogue to resolution—are reflected in correspondingly gradual prosodic changes rather than abrupt shifts. The narrative arc analysis may operate on a sliding window of text segments, with the window length ranging from about 50 words to about 500 words, preferably from about 100 words to about 300 words. In certain embodiments, a user may override the automatically detected emotional classification for any text segment, and such overrides may be stored in the user's reading profile for training a personalized emotion model.

According to at least one embodiment, the system further comprises a biometric sensor module configured to capture physiological data of the user during the reading process. The biometric sensor module may comprise one or more sensors selected from the group consisting of an eye-tracking camera, a pupillometer, an electroencephalography (EEG) headband, a galvanic skin response (GSR) sensor, a photoplethysmography (PPG) sensor, a heart rate variability (HRV) monitor, an electromyography (EMG) sensor for facial muscle activity, and/or combinations thereof. The captured physiological data are transmitted to the processing unit and correlated with the speech output timeline.

In at least one embodiment, the processing unit uses the biometric data to infer cognitive load, attention level, and/or emotional engagement of the user. Cognitive load may be inferred from pupil dilation, blink frequency, and/or theta-band EEG power (4-8 Hz). Attention level may be inferred from gaze fixation duration, saccade frequency, and/or alpha-band EEG power (8-13 Hz). Emotional engagement may be inferred from GSR amplitude, heart rate variability, and/or facial EMG activity corresponding to zygomatic (smile) and corrugator (frown) muscles.

Based on the inferred cognitive state, the processing unit may automatically adjust one or more of the following parameters: reading speed (decreased upon detection of high cognitive load or low attention), marking mode granularity (switched from sentence-level to word-level upon detection of comprehension difficulty), speech synthesis prosody (adjusted to more emphatic intonation upon detection of declining engagement), and/or difficulty of upcoming text segments (if the system has access to a content difficulty model). In certain embodiments, the biometric-based adjustments are weighted against the adaptive learning model, such that short-term biometric signals modulate long-term reading profile predictions.

In at least one embodiment, the system integrates gamification elements for motivating the user and encouraging sustained reading practice. The gamification elements may comprise one or more of the following: a reading progress score, reading streaks (consecutive days of reading practice), achievement badges, leaderboard rankings (optionally anonymized), timed reading challenges, comprehension quizzes generated automatically from the text content, and/or experience points (XP) that accumulate across reading sessions. The reading progress score may be computed as a weighted combination of total words read, reading accuracy, average reading speed, and/or time spent reading, with the weights being configurable by the user or by an administrator.

In a further embodiment, the gamification system is configured to adapt its difficulty and reward structure to the user's skill level using a spaced repetition algorithm. Words or passages that the user has read incorrectly may be flagged for repeated presentation in subsequent sessions, with the repetition interval increasing upon each correct reading. The spaced repetition algorithm may implement the Leitner system, the SM-2 algorithm, and/or a neural-network-based scheduler. In certain embodiments, the gamification elements may be selectively disabled for professional or clinical use cases where gamification is not desired.

According to at least one embodiment, the system is operable in an offline mode without network connectivity. In the offline mode, the processing unit performs voice synthesis, text marking, reading accuracy analysis, and adaptive speed adjustment entirely on the local device using locally stored models. The voice cloning model may be compressed for on-device inference using model quantization, knowledge distillation, and/or pruning techniques. In certain embodiments, the compressed on-device model has a memory footprint of less than about 500 megabytes, preferably less than about 200 megabytes, more preferably less than about 100 megabytes, and most preferably less than about 50 megabytes.

When the device returns to network connectivity after a period of offline operation, the system may synchronize the accumulated reading data, updated reading profiles, and/or gamification progress with the cloud storage. Conflict resolution between locally accumulated data and cloud-stored data may be performed using a last-write-wins strategy, a merge strategy based on timestamps, and/or a user-prompted manual resolution. In certain embodiments, the offline mode is automatically activated upon detection of network loss and automatically deactivated upon detection of network availability, without requiring user intervention.

In at least one embodiment, the system integrates accessibility features for users with visual impairments, motor impairments, and/or cognitive disabilities. The accessibility features may comprise one or more of the following: screen reader compatibility with ARIA landmarks and live regions, adjustable font sizes ranging from about 8 points to about 72 points, high-contrast display modes, dyslexia-friendly font options (such as OpenDyslexic or Lexie Readable), reduced-motion mode for users sensitive to animation, switch access compatibility for users with motor impairments, and/or voice-only navigation mode.

According to a further embodiment, the system provides Braille synchronization, wherein the text marking is transmitted in real time to a connected Braille display device via a wireless communication protocol, such as Bluetooth Low Energy (BLE) or Wi-Fi. The Braille display may render the currently highlighted word, syllable, or morpheme in Braille characters that advance in synchronization with the speech output. In certain embodiments, the Braille synchronization supports Grade 1 (uncontracted) Braille, Grade 2 (contracted) Braille, and/or Unified English Braille (UEB). For multilingual applications, the Braille synchronization may additionally support the Braille systems of other languages, including but not limited to French Braille, German Braille (Blindenschrift nach Marburg), and/or Mandarin Braille (Xianxingmang).

In at least one embodiment, the system comprises a parental control module that permits a parent or guardian to configure content restrictions, maximum daily usage time, and/or approved text libraries for a child user. The parental control module may be protected by a passcode, biometric authentication, and/or two-factor authentication. In certain embodiments, the parental control module generates periodic reports summarizing the child user's reading activity, including total reading time, words read, accuracy metrics, and/or gamification progress. The reports may be transmitted to the parent via email, push notification, and/or an in-app dashboard.

According to at least one embodiment, the system supports a collaborative reading mode in which two or more users participate in a shared reading session. In the collaborative reading mode, the text may be divided into segments assigned to different users, with each user reading their assigned segment aloud while the other users follow along with synchronized marking. The processing unit may analyze the reading accuracy of each user independently and provide individualized feedback. In certain embodiments, the collaborative reading mode operates over a network connection, such that users at different physical locations may participate in the same reading session via real-time audio and data streaming.

In at least one embodiment, the system comprises a content difficulty classifier that automatically assesses the difficulty level of a given text prior to or during reading. The content difficulty classifier may compute one or more readability metrics selected from the group consisting of Flesch-Kincaid Grade Level, Gunning Fog Index, Coleman-Liau Index, SMOG Index, Automated Readability Index, and/or a neural-network-based readability estimator. Based on the assessed difficulty level and the user's proficiency level as stored in the reading profile, the processing unit may automatically adjust the default reading speed, the marking granularity, the frequency of comprehension prompts, and/or the activation of the lexicon function.

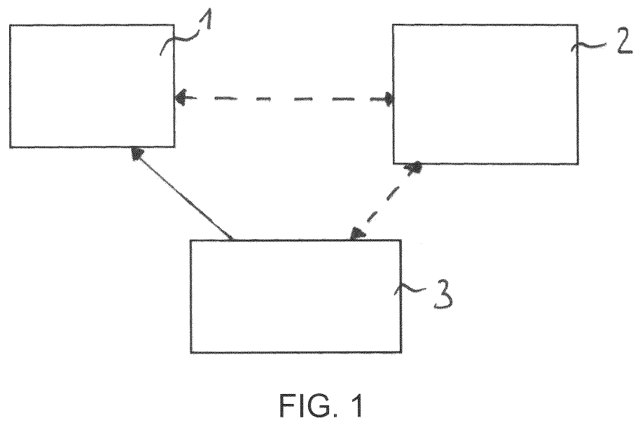

Referring now to FIG. 1, which shows a schematic diagram of an exemplary system for synchronized speech output with textual marking. The system comprises a display device 1, an audio output system 2, and a processing unit 3. The processing unit 3 is configured to synchronize the speech output of a text 7 (shown in FIG. 3) with a corresponding marking on the display device 1. In this embodiment, this enables the user to simultaneously visually follow the text 7 (shown in FIG. 3) being read aloud. The processing unit 3 may support various synchronization modes to accommodate individual preferences of the user. The processing unit 3 may be implemented as a microprocessor, a digital signal processor (DSP), a field-programmable gate array (FPGA), an application-specific integrated circuit (ASIC), and/or a general-purpose computing device executing software instructions. In certain embodiments, the system further comprises an audio input system 11 communicatively coupled to the processing unit 3 for capturing speech of the user.

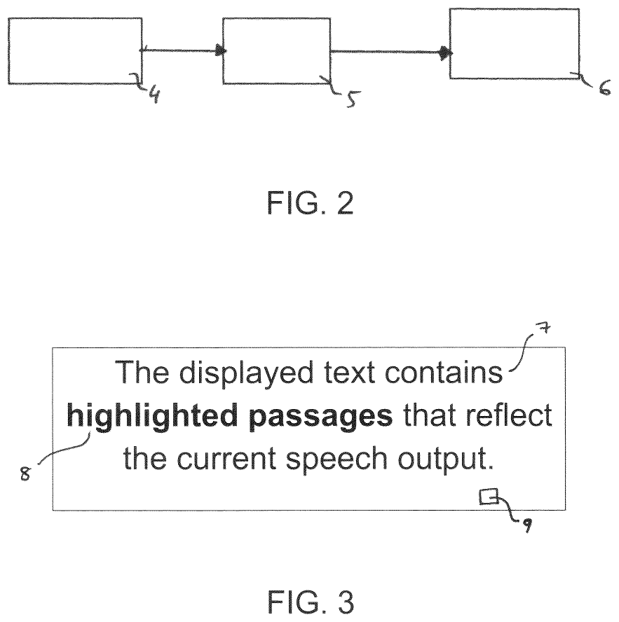

FIG. 2 illustrates an embodiment of this disclosure which comprises a process for generating a personalized synthesized voice. In this embodiment, the process begins with an initial voice recording 4, during which the user speaks a predetermined quantity of text 7 (shown in FIG. 3). Subsequently, processing 5 occurs, during which the recorded speech data are analyzed and, preferably converted into a model suitable for machine learning. In a cloning step 6, a synthesized voice is created therefrom that corresponds to the individual characteristics of the original voice. The personalized voice may then be integrated into the system and used for speech output. Processing 5 may involve feature extraction, speaker embedding computation, and/or acoustic model training, among other techniques known in the art.

FIG. 3 shows an exemplary user interface of a system for synchronized speech output. The displayed text 7 contains highlighted passages 8 that reflect the current speech output. Additionally, control elements 9 are provided for controlling the reading speed and for adapting the synchronization. The user interface may further include options for adapting voice properties or for selecting a personalized synthesized voice. A playback speed indicator may optionally be displayed to provide visual feedback regarding the current reading speed setting. In certain embodiments, a gamification display area is shown adjacent to the text area, displaying user data which may include, but is not limited to reading progress, achievement indicators, and/or streak information.

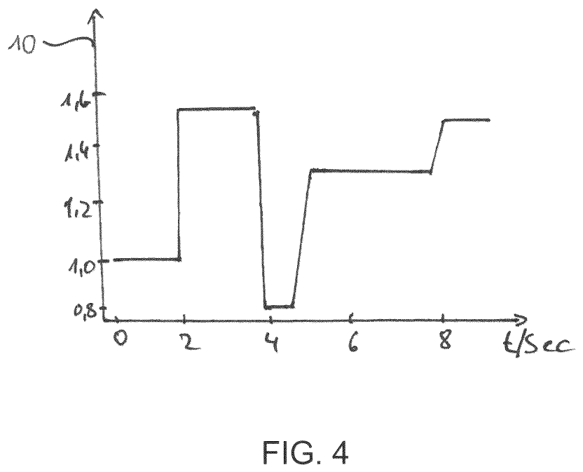

FIG. 4 shows a diagram for the automatic adaptation of the reading speed in dependence on user interactions. In an embodiment, the system continuously captures inputs from the user, such as manual adjustment of the playback speed or skipping forward and backward in the text 7. Based on these interactions, a dynamic modification of the playback speed 10 is performed by the processing unit 3 (shown in FIG. 1). In this embodiment, the system may use machine learning-based algorithms to adapt to the preferred reading speed of the user and thereby to provide an optimal listening experience. In embodiments comprising a biometric sensor module, the diagram further represents physiological data inputs that modulate the speed adaptation in real time.

### REFERENCE NUMERAL LIST

1 Display device
2 Audio output system
3 Processing unit
4 Voice recording
5 Processing
6 Cloning step
7 Text
8 Highlighted passage
9 Control element
10 Playback speed

What is claimed is:

1. A method for automated speech output with personalized voice cloning and synchronous marking, the method comprising:
generating, via a processing unit, a synthesized voice by way of voice cloning technology based on an initial voice recording;
synchronously marking, via the processing unit, read text passages on a display device in dependence on the speech output;
controlling, via the processing unit, a reading or reading-aloud speed of the speech output;
analyzing reading or reading-aloud accuracy of a user immediately during reading and/or immediately after each word, each syllable, and/or each morpheme by way of a real-time feedback system; and
utilizing an AI-based model to recognize and optimize at least one of an individual reading or reading-aloud speed and a reading or reading-aloud accuracy of the user.

2. The method of claim 1, wherein a self-learning system employing kernel technology is used to continuously optimize the speech output and to dynamically adapt the speech output based on prior user inputs.

3. The method of claim 1, wherein the reading or reading-aloud speed is automatically adapted to a reading pace of the user based on at least one of eye-tracking data, user-initiated speed changes, scrolling velocity, environmental noise level, prior user behavior, and prior user reading patterns.

4. The method of claim 1, wherein the speech output is combined with real-time speech analysis for recognition of speech modulations and intonations.

5. The method of claim 1, further comprising storing individual reading profiles and using the individual reading profiles for adapting the speech output.

6. The method of claim 1, wherein the marking of the text passages occurs in a form selected from the group consisting of morpheme-by-morpheme marking, syllable-by-syllable marking, word-by-word marking, and sentence-by-sentence marking.

7. The method of claim 1, further comprising storing personalized speech data generated by the voice cloning technology in a cloud-based storage system for cross-platform use.

8. The method of claim 1, further comprising integrating multilingual support for simultaneous translations into the speech output, wherein personalized voice characteristics are maintained across languages.

9. The method of claim 1, wherein the speech output is controlled via a multimodal interface comprising at least one of voice input, touchscreen control, and gesture recognition.

10. The method of claim 1, further comprising:
performing, via the processing unit, a sentiment analysis of the text to be read aloud to classify text segments into emotional categories; and
adapting at least one prosodic parameter of the synthesized voice based on the classified emotional category, the at least one prosodic parameter being selected from the group consisting of fundamental frequency contour, speaking rate, loudness, spectral tilt, jitter, shimmer, and voice quality.

11. The method of claim 1, further comprising:
capturing, via a biometric sensor module, physiological data of the user during reading, the physiological data comprising at least one of pupil dilation data, electroencephalography data, galvanic skin response data, and heart rate variability data;
determining, via the processing unit, at least one of a cognitive load, an attention level, and an emotional engagement of the user from the captured physiological data; and
automatically adjusting at least one of the reading speed, the marking granularity, and the speech synthesis prosody based on the determined cognitive load, attention level, and/or emotional engagement.

12. The method of claim 1, further comprising computing a reading progress score as a weighted combination of total words read, reading accuracy, average reading speed, and time spent reading, and presenting the reading progress score to the user as a gamification element.

13. The method of claim 1, wherein the generating, the synchronously marking, the controlling, the analyzing, and the utilizing are performed entirely on a local device without network connectivity using locally stored models having a memory footprint of less than about 500 megabytes.

14. The method of claim 1, further comprising transmitting, in real time, the currently highlighted word, syllable, or morpheme to a connected Braille display device for rendering in Braille characters in synchronization with the speech output.

15. The method of claim 1, further comprising supporting a collaborative reading mode in which two or more users participate in a shared reading session, wherein the text is divided into segments assigned to different users, and reading accuracy is analyzed independently for each user.

16. The method of claim 1, further comprising automatically assessing a difficulty level of the text using at least one readability metric and adjusting at least one of the reading speed and the marking granularity based on the assessed difficulty level and a proficiency level of the user.

17. The method of claim 1, further comprising:
capturing, by an audio input system, speech of the user reading along with the speech output;
comparing, by the processing unit, the captured speech of the user with an expected pronunciation derived from the text; and
providing feedback to the user upon detection of a pronunciation error, the feedback comprising at least one of a visual indication on the display device, an auditory indication through the audio output system, and a haptic indication.

18. A system for automated speech output with personalized voice cloning and synchronous marking, the system comprising:
a display device configured to display text;
an audio output system configured to output synthesized speech; and
a processing unit communicatively coupled to the display device and the audio output system, the processing unit being configured to:
generate a synthesized voice by way of voice cloning technology based on an initial voice recording;
synchronously mark read text passages on the display device in dependence on the speech output;
control a reading speed of the speech output;
analyze reading accuracy of the user immediately during reading and/or immediately after each word, each syllable, and/or each morpheme by way of a real-time feedback system; and
utilize an AI-based model to recognize and optimize at least one of an individual reading speed and a reading accuracy of the user.

19. The system of claim 18, further comprising a biometric sensor module communicatively coupled to the processing unit, the biometric sensor module comprising at least one of an eye-tracking camera, a pupillometer, an electroencephalography headband, and a galvanic skin response sensor, wherein the processing unit is further configured to adjust the reading speed and/or the marking granularity based on physiological data captured by the biometric sensor module.

20. The system of claim 18, further comprising an audio input system communicatively coupled to the processing unit, the audio input system being configured to capture speech of the user for comparison with an expected pronunciation derived from the text, wherein the processing unit is further configured to provide feedback to the user upon detection of a pronunciation error.
